(19) United States
(12) Patent Application Publication
(10) Pub. No.: US 2018/0103215 A1
(43) Pub. Date: Apr. 12, 2018

(54) FOVEAL POWER REDUCTION IN IMAGERS

(71) Applicant: KAPIK INC., Toronto (CA)

(72) Inventor: William Martin SNELGROVE, Toronto (CA)

(21) Appl. No.: 15/730,208

(22) Filed: Oct. 11, 2017

Related U.S. Application Data
(60) Provisional application No. 62/406,456, filed on Oct. 11, 2016.

(51) Int. Cl. H04N 5/341; H04N 5/369; H04N 5/232

(52) U.S. Cl. CPC H04N 5/341; H04N 5/23241; H04N 5/3696

(57) ABSTRACT

An imaging device includes an imager to capture an image, a controller to control the imager to define a dynamic electronic fovea. The dynamic electronic fovea is defined by a subset of pixels of the imager. The subset of pixels for the fovea is driven differently from a remainder of pixels of the imager.

### CROSS-REFERENCE TO RELATED APPLICATIONS

This application claims the benefit of U.S. provisional patent application Ser. No. 62/406,456, filed Oct. 11, 2016, which is incorporated herein by reference.

### BACKGROUND

Digital imaging requires power. Adequate power may not be available for various imaging applications, such as gesture tracking. This problem is more pronounced on mobile devices, such as smartphones, which typically rely on battery power.

### BRIEF DESCRIPTION OF THE FIGURES

FIG. 1 is a block diagram of an example imaging device.

FIG. 2 is a schematic diagram of row and column driven pixels of an imager defining an example fovea.

FIG. 3 is a schematic diagram of row and column driven pixels of an imager defining an example foveae.

FIG. 4 is a schematic diagram of row and column driven pixels of an imager defining an example fovea and an example perifovea.

FIG. 5 is block diagram of an example electronic device.

FIG. 6 is a circuit diagram of an example pixel driving circuit.

FIG. 7 is a circuit diagram of another example pixel driving circuit.

### DETAILED DESCRIPTION

The present invention relates to reducing or minimizing the power consumption of an imaging device. More specifically, the present invention relates to scanning different areas of an image at different quality levels, said areas and quality levels responsive to the intended use of the image.

Electronic imagers are widely used, for example, with one or two in most smartphones. However, their high power consumption limits their application. For example, it is often desirable to detect and track gestures of a smartphone user, and it is known to track gestures by processing streams of frames from an imager chip or chips. Using this technique in an “always-on” mode would simplify user-phone interaction and allow new applications and features. However, power consumption of the imager chip in this mode drains the smartphone battery too quickly.

Imagers often include a rectangular array of pixels, each pixel converting optical signals to analog electrical signals. In the array, one row at a time is selected, analog electrical signals are passed from all pixels in the selected row down column wires connected to analog-to-digital converters that convert the originally optical signal into digital form. The resulting data is usually passed to a digital signal processing system to extract the desired information, such as storage as a video or interpretation to find faces or track gestures.

Spatially subsampling pixels on an imager chip may save power, but sub sampling may also reduce the resolution of an image and may make accurate sensing of gestures difficult or impossible. Temporally subsampling—for example by reducing frame rate—may save power, but this may limit accurate sensing of rapid gestures.

Some conventional imagers are constrained to have a uniform pixel array so as to produce a uniform image. This means that row and column wiring must typically run the whole width or height of the array, driving all pixels en route. An array of micro-lenses may be used to focus light reaching the image plane on the optically sensitive portion of each pixel, avoiding wasting photons on wiring. In contrast to imagers, the row-column structure in memory arrays is broken by hierarchical wiring arrangements that allow portions of the memory array to be activated without driving all of the array. Further, “fly's eye” optics, which have optical spatial redundancy, may be used for the purpose of filling in for failed pixels.

In addition to the power consumed by the image sensor itself, power is consumed by the signal processing required to interpret its images. Reducing image resolution (spatially or in time) saves processing power.

In addition to consuming power for acquisition and processing, storing unnecessary data consumes memory and transmitting such data consumes communication resources such as network bandwidth and radio power. Image coding, such as JPEG and MPEG coding, may reduce or minimize data while maintaining acceptable perceptual quality, but initial data acquisition is usually done at full resolution and therefore consumes unnecessary power. Always-on video recording, such as in body-cams, deals with this by reducing image quality, which is often an undesirable compromise.

Imagers typically resolve multiple channels of color, not just intensity, and some resolve wavelengths not visible to the eye and/or color spectral detail not visible to the eye. Some imagers also resolve depth or motion. All these additional channels of data may be useful in applications that use imagers for such things as gesture and behaviour tracking, but the more data that is acquired the more power is consumed.

In present technologies, each sample acquired from an image requires about 1-10 nJ of energy. Known “figures of merit” for circuits able to convert optical and electrical signals to digital form for convenient processing are known to require energy of roughly this order, so the problem is inherent to sampling information.

Human eyes have a small foveal region, which has higher spatial resolution than the peripheral region, and which resolves color in more detail. It is thought that approximately half of the total information rate fed back into the brain by the eye comes from this region, although it occupies roughly one one-thousandth of the area of the retina. Muscles move the eye so that areas of interest image onto the fovea. A small network of neurons is used to track moving objects and to compensate for head motion; and that higher-level processing is used to choose areas of interest in a scene. The distinction between fovea and periphery is not sharp: there is also a perifovea with intermediate resolution surrounding the fovea proper.

Artificial neural networks may be used for analyzing scenes captured using conventional imagers, and attentional neural networks may be used to select a sequence of areas of interest in order to analyze an image.

The present invention controls an imager in a way that reduces or minimizes the amount of data acquired in order to interpret a scene, including a moving scene, thereby reducing or minimizing power consumption.

The present invention provides techniques for reducing or minimizing the data acquired in an imager while preserving the value of the image. Examples include, but are not limited to, allowing always-on recognition and tracking of gestures and behaviour in mobile and wearable devices and allowing increased quality in video recording.

According to aspects of the present invention, there is provided a variable-quality image sensing system. The variable-quality image sensing system includes an imager operable to acquire data in one or more regions of its surface at a high quality while the remainder of the image is acquired at lower quality or not at all; and circuitry/components/hardware/software to manage said imager responsive to the needs of a particular application or applications (manager). “High quality” in this sense includes, but is not limited to, sensing at high spatial resolution, at high frame rates, at fine sample resolution, sampling depth at all or at high resolution, and sensing color or extended spectral information. The “needs of a particular application” include, but are not limited to, tracking hand gestures, tracking facial gestures, tracking gaze, and improving video image quality available at a given power level.

Hierarchical wiring in the imager pixel array may be used to allow efficient activation of small areas; and the resulting blind areas at the image plane may be compensated using “fly's eye” or Fresnel optics modified to create an optical image that focuses only on the active area. Residual optical distortion may be compensated digitally, creating an apparently uniform image.

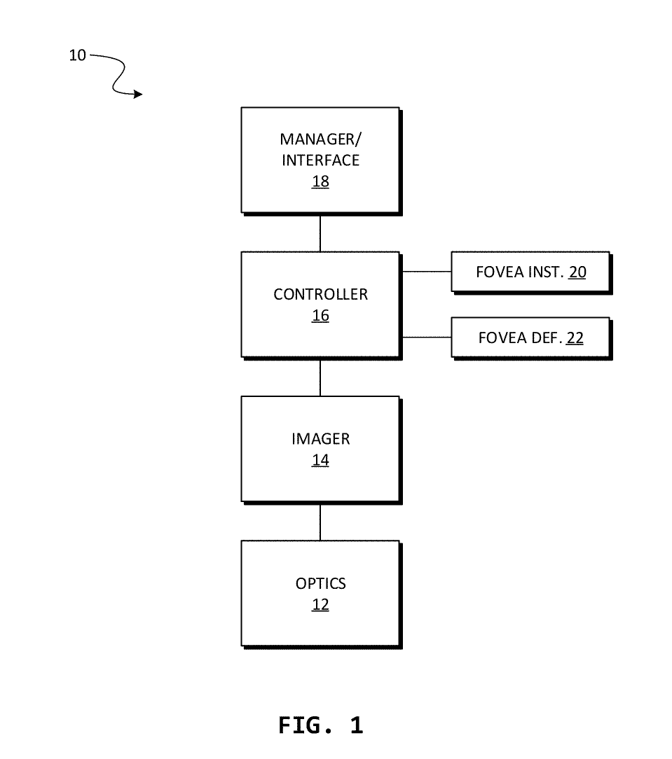

As shown in FIG. 1, an imaging device 10 may include optics 12, an imager 14, a digital controller 16, and a manager or interface 18. The imaging device 10 may be provided to a computer device such as a smartphone, tablet computer, digital camera, notebook computer, or the like.

The optics 12 may include a lens, such as a Fresnel lens, fly's eye lens, or similar, to capture and direct light to the imager 14.

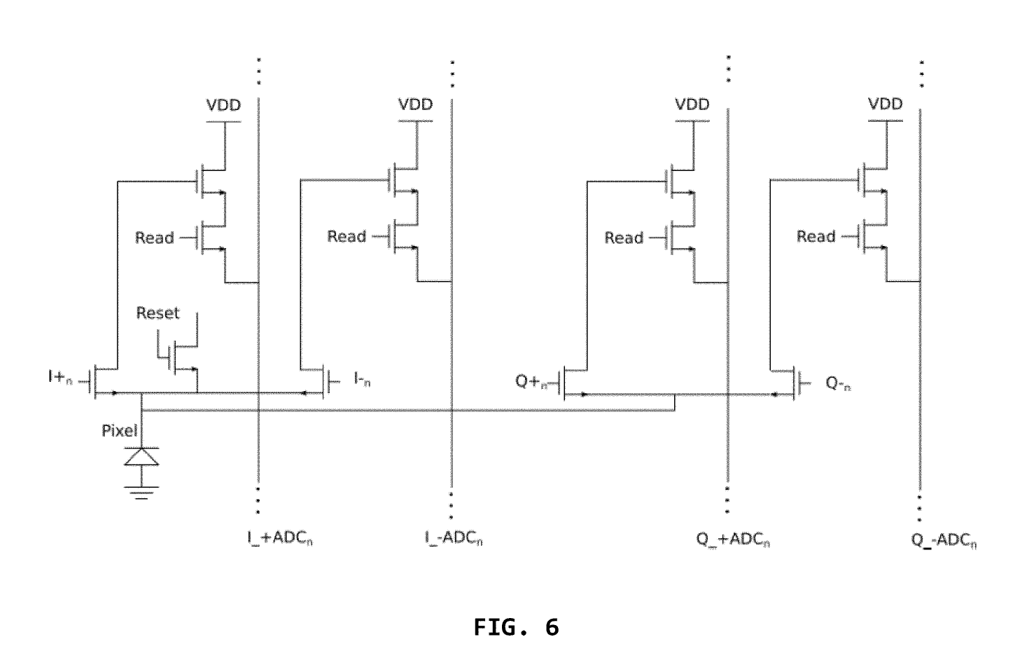

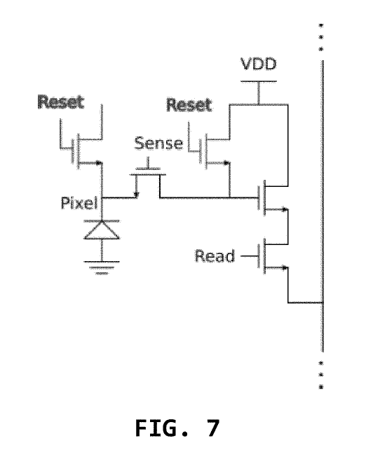

The imager 14 may include a semiconductor charge-coupled device (CCD), active pixel sensors in complementary metal-oxide-semiconductor (CMOS), N-type metal-oxide-semiconductor (NMOS), or similar. The imager 14 may implement a Bayer pattern or apply similar technique for color separation. The imager 14 defines an array of pixels. Circuity for an example pixel is shown in FIG. 6, which depicts a portion of an example four-phase +-I/+-Q imager. Another example of circuity for an example pixel is shown in FIG. 7. Further examples of pixel driving circuitry are contemplated and the specific circuitry used may be selected based on specific implementation requirements.

The controller 16 may include a processor, a microcontroller, a microprocessor, a processing core, a field-programmable gate array (FPGA), a hardwired logic array, or similar device capable of executing instructions. The controller 16 may cooperate with memory to execute instructions. The controller 16 and memory may be integrated. Memory may include a non-transitory machine-readable storage medium that may be any electronic, magnetic, optical, or other physical storage device that stores executable instructions. The machine-readable storage medium may include, for example, random access memory (RAM), read-only memory (ROM), electrically-erasable programmable read-only memory (EEPROM), flash memory, and the like. The machine-readable storage medium may be encoded with executable instructions that give the controlled 16 the functionality discussed herein.

Fovea instructions 20 and a fovea definition 22 may be provided for the controller 16. Fovea instructions 20 may contain instructions to drive the imager 14 to capture a subset of pixels that are fewer than the total pixels of the imager 14. A fovea definition 22 may be a set of parameters that device a fovea. Any number of fovea definition 22 may be provided to define any number of foveae and perifoveae. An example fovea definition 22 contains parameters for size and position of a fovea. Another example fovea definition 22 contains parameters for size, position, capture wavelength spectrum, and movement conditions for a movable fovea.

The controller 16 may be operable to apply clocking signals to the imager 14 that allow selection of a fovea or plural foveae and to place the resulting data in buffers. The controller 16 may be operable to estimate power consumption, so that higher-level functions, such as that provided by the manager or interface 18, may reduce or minimize power. The controller 16 may be operable to track image movement, so that higher-level functions may be presented with an image with reduced movement. The controller 16 may be operable to subsample the image peripheral to the foveae, such subsampling being, for example, in space by combining or decimating rows and columns. Additionally or alternatively, such subsampling may be in time by, for example, sampling the foveae and periphery at different rates. Additionally or alternatively, such subsampling may be in spectrum by, for example, combining color channels. Additionally or alternatively, such subsampling may be in dimension by, for example, disabling time-of-flight measurements. Additionally or alternatively, such subsampling may be in resolution by, for example, using less accurate analog-to-digital conversion. Any combination of these techniques may be implemented at the controller 16. The controller 16 may be operable to sample plural foveae of different sizes at different spatial, temporal, spectral, or intensity resolutions.

The manager or interface 18 provides high-level control to the controller 16. A manager may include a processor and memory that cooperate to execute instructions and implement high-level functionality, such as a neural network. An interface may be a data bus or other interface that communicates commands and data between the controller 16 and a processor that is not part of the device 10. The manager or the processor connected to the interface may be termed a higher-level signal processing system.

A higher-level signal processing system, for example, a convolutional neural net, may be implemented at a manager or connected to an interface to extract desired high-level features from the data buffered by the controller 16. This higher-level signal processing may make decisions as to what areas should become foveae, feeding these decisions down to the controller 16.

The roles of rows and columns may be interchanged. Multiple imagers 14 may be provided to the device 10, as for example in stereo vision. Imagers 14 so combined may be of different types, such as visible-light and infrared imagers, or conventional and time-of-flight imagers.

A controller 16 may control an imager 14 to define one or more dynamic electronic foveae. An electronic fovea is a sub-region of the imager that is, for a time, activated differently (e.g., driven at higher frequency, driven to capture additional frames/data, driven to capture additional wavelengths of light, etc.) to the remaining region of the imager 14 and is thus capable of capturing additional image information. The pixel pitch of the imager 14 may be kept constant or kept in accordance with conventional arrangements, and no special pixel layout is needed. Each pixel of the imager is capable of being part of a fovea, depending on how the pixel is driven. An electronic fovea may save power over the conventional technique of increasing the driving frequency (or other parameter) of the entire imager. Electronic fovea may be combined with other techniques, such as time-of flight distance measurements, to enable new uses for the digital camera or similar device, such as always-on or nearly-always-on three-dimensional gesture capture, eye tracking, and the like.

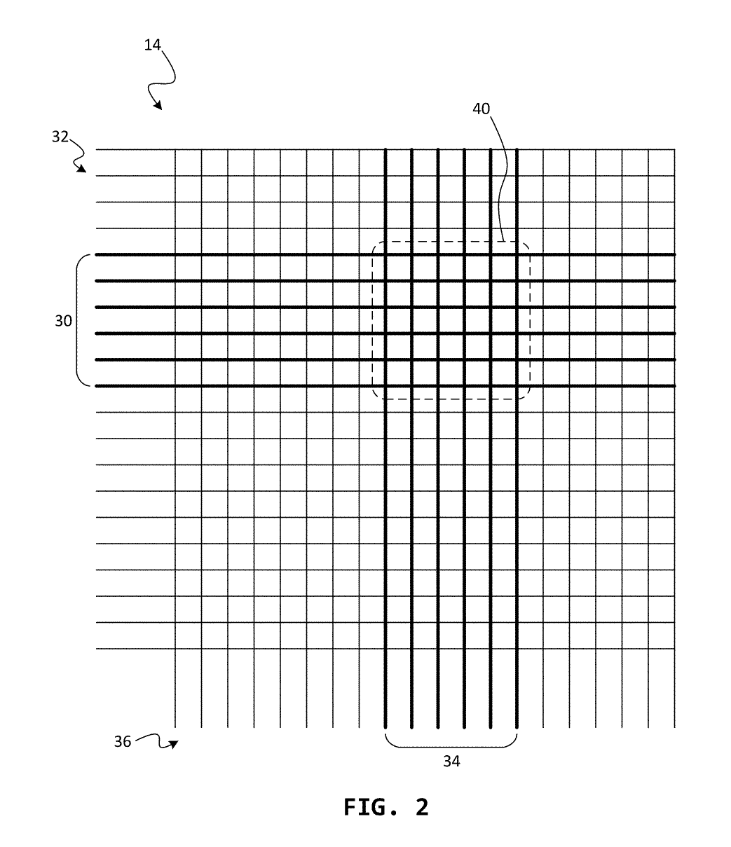

With reference to FIG. 2, the controller 16 may be configured to activate a subset 30 of rows 32 and a subset 34 of columns 36 of the pixels of imager 14. The intersection of the subset 30 of rows and the subset 34 of columns defines a subset of pixels for a fovea 40. Each subset 30, 34 may be defined by any number of respective rows and columns fewer than the respective total provided to the imager 14. In a typical arrangement of rows and columns, a fovea 40 may thus take any rectangular shape. A fovea 40 may be dynamic, in that the controller 16 may activate, deactivate, move, modify, reshape, etc. the fovea over time. During operation, the subset 30 of rows may be scanned and the subset 34 of columns may be enabled, or vice versa.

The rows and columns of the fovea 40 may be driven at a particular capture quality (e.g., frequency of 100 frames per second or FPS) or according to one or more other parameters, so as to capture movement more conducive to gesture recognition, such as fast hand, finger, or lip movements. The fovea 40 may be driven differently from the remainder of the imager 14 using any suitable parameter set (e.g., capture frequency, size, position), so as to capture higher quality sub-images. The imager 14 may be configured to change fovea parameters over time and/or according to triggers. A fovea 40 may be square or rectangular and may occupy any position on the imager 14. A fovea 40 may be created or destroyed by adjusting the relevant parameters of the fovea 40 or the remainder of the pixels of imager 14.

It is contemplated that driving the fovea 40 to capture at a higher quality than the remainder of the imager's pixels may cause the fovea 40 to capture additional data that may be used for purposes, such as gesture recognition, other than conventional image capture. In addition to or as an alternative to higher-frequency sampling, capture wavelength spectrum may be a parameter used to define a fovea 40. For instance, if the RGB pixels of the imager are configured to capture visible images, a fovea 40 may be defined to capture another wavelength spectrum, such as a spectrum that includes infrared light. Overlap among captured spectra is possible. Capture of visible image and fovea 40 data may be simultaneous or time interleaved. For instance, if the RGB pixels of the imager are configured to capture desired visible images at 30 FPS, a fovea 40 may be defined using white or RBG pixels having a greater spectrum and captured at, for example, 30 FPS (or more). Alternatively, if the RGB pixels of the imager capture a desired visible image at 30 FPS, a fovea 40 may be defined using one or more of the R, G, or B pixels captured at, for example, 30 FPS (or more) offset in time from the RGB capture. These frequency (FPS) and color values are simply examples. The image information captured by the imager 14 for other purposes (e.g., recording video) may be used to supplement the fovea 40. For example, data of red pixels of video captured at 30 FPS may be used as fovea data in combination with specific fovea data frames captured at 30 FPS (or more) using the red pixels of the imager.

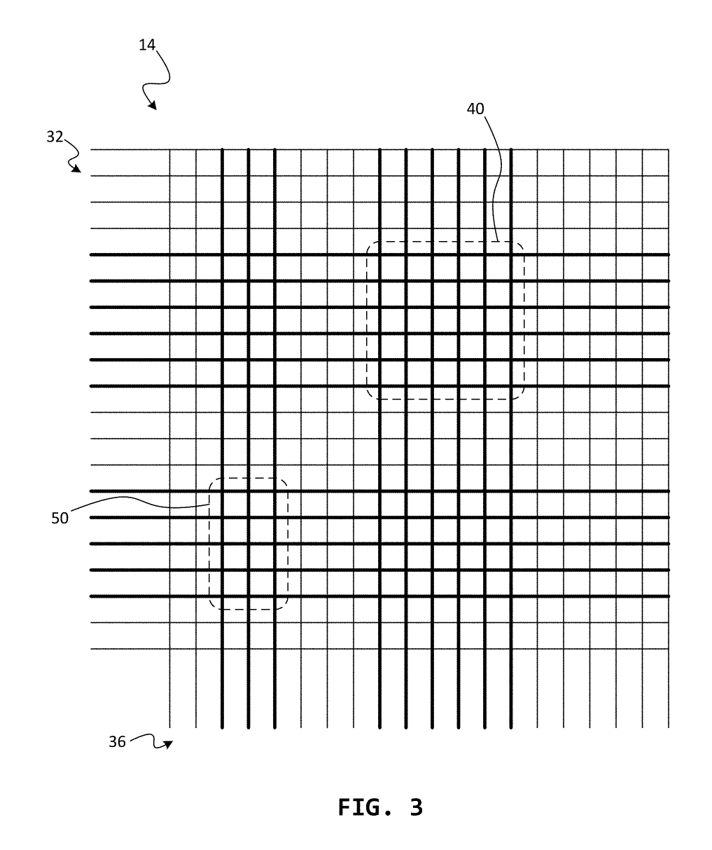

The same imager 14 may be configured with multiple foveae. As shown in FIG. 3, one or more additional foveae 50 may be provided, so as to capture additional movement conducive to complex gesture recognition. Considering the example of American Sign Language, two foveae 40, 50 may be established to capture images of signer's the hands and one fovea may be established to capture images of the signer's face. The multiple foveae 40, 50 may be controlled to capture at the same quality. Alternatively, to save additional power, one or more of the foveae 40, 50 may be controlled to capture at a lower quality, such as 20 FPS. For instance, if it is determined that the signer's face moves slower than the hands, the fovea dedicated to the face may have its capture frequency (or other parameter) reduced. Each foveae 40, 50 may be defined independently, in that each foveae 40, 50 may have the same or different exposure times, sizes, sampling frequencies, target wavelengths, etc.

Fovea capture parameters may be configured to be adaptive based on movement speed or other characteristic. For instance, if a sub-image captured by a fovea is determined to increase in movement speed (as measurable by conventional techniques), the capture frequency of that fovea may be increased. Size, position, and quantity of foveae may also be adaptive.

The imager 14 may be configured use captured visible light (R, G, B, or a combination) and/or non-visible light (e.g., infrared) for time-of-flight techniques in combination with known illumination provided by the device carrying the imager.

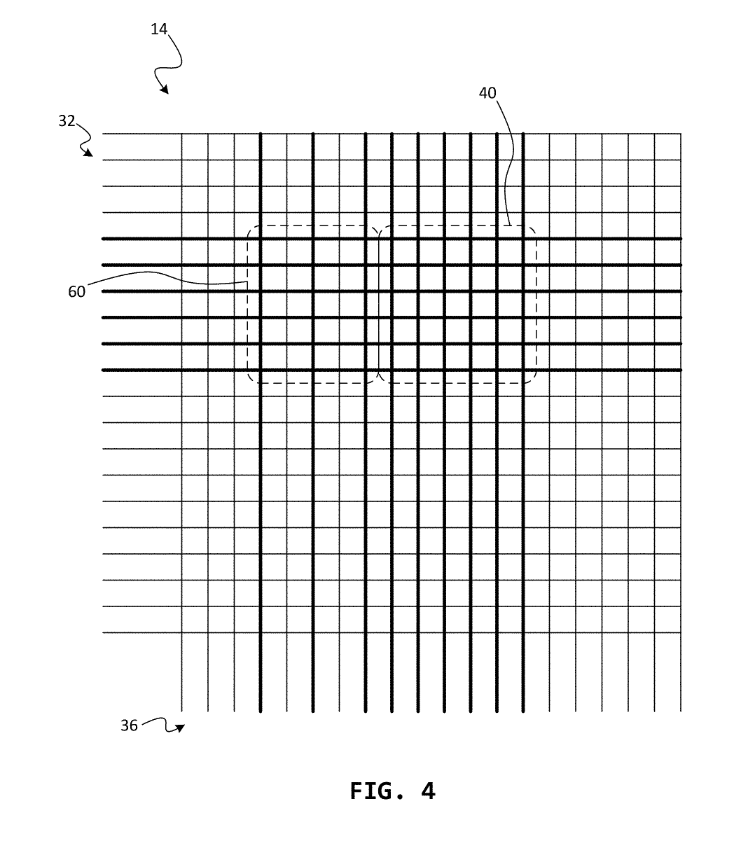

As shown in FIG. 4, one or more regions 60 adjacent to a fovea may define a perifovea and may be driven to capture at a lower quality than the main fovea 40 but at a quality higher than the remainder of the imager 14. Capturing at lower quality may be achieved by activating fewer rows/columns than available. A perifovea 60 may be used to detect potentially unexpected movement exiting or entering the main fovea 40 or other characteristic(s) that may require adjustment to the parameters (e.g., capture frequency, size, position, etc.) of the main fovea 40. Perifoveae may save additional power as compared to a larger main fovea, in that a perifovea needs to captured less data over time than a main fovea. Multiple perifoveae may be provided to a main fovea, such that sensitivity gradual decrease away from the main fovea.

In some examples, a pixel array has one, two, or more foveae that are created by selectively driving rows and receiving on columns. In further examples, a pixel array has a fovea that is sampled at every row and column, a perifovea is sampled at half the rows and half the columns, and a periphery (remainder) is sampled at one-quarter of the rows and one-quarter of the columns.

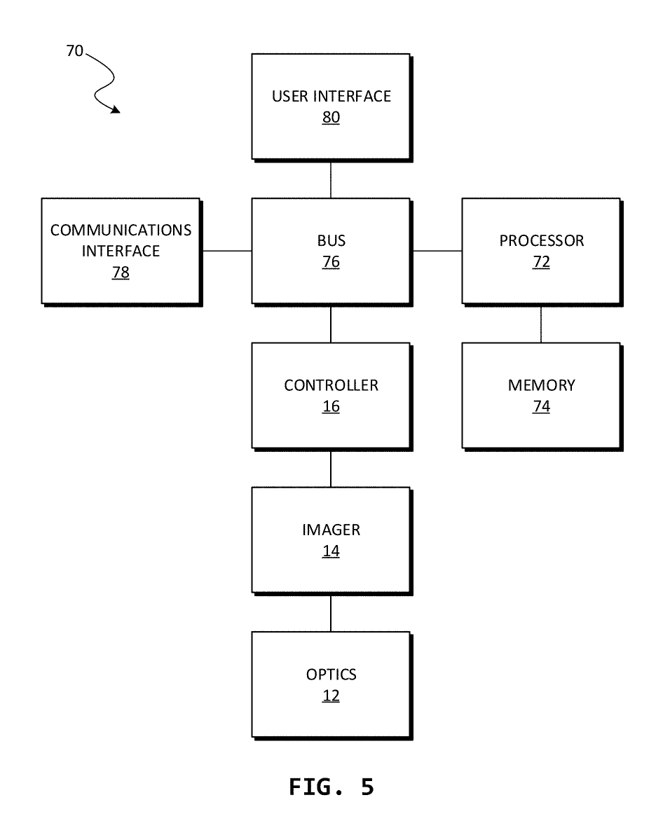

As shown in FIG. 5, an imager 14 configured to provide one or more fovea and/or perifoveae according to the present invention may be included as a component of an electronic device 70, such as a smartphone, tablet computer, desktop/laptop computer, screen, dedicated gesture/motion capture device, or similar device. The imager 14 may provide image information to other components of the device 70. The imager 14 may be the same imager used to capture photos/video or may be a different imager.

The device 70 may include a processor 72, memory 74, a bus 76, a communications interface 78, and a user interface 80. The processor 72 and memory 74 cooperate to execute instructions to provide functionality to the device 70. An operating system and applications may be provided. The bus mutually connects the processor 72, imager controller 16, communications interface 78, and user interface 80. The communications interface 78 may include a wireless interface for communications with a wireless network. The user interface 80 may include a touchscreen, keyboard, microphone, and the like. Higher-level functionality, such as commands and signal processing, related to a foveal functionality implemented by the controller 16 may be provided locally by the processor 72 and/or via the communications interface 78, in the case of remote processing.

It should be apparent from the above that the techniques described herein may save power in various imaging applications and may enable always-on imaging applications, such as gesture tracking, in power-constrained electronic devices.

While the foregoing provides certain non-limiting examples, it should be understood that combinations, subsets, and variations of the foregoing are contemplated. The monopoly sought is defined by the claims.

What is claimed is:

1. An imaging device comprising:
an imager to capture an image; and
a controller to control the imager to define a dynamic electronic fovea, the dynamic electronic fovea defined by a subset of pixels of the imager that is driven differently from a remainder of pixels of the imager.

2. The device of claim 1, wherein the controller is operable to activate a subset of rows and a subset of columns of the imager, an intersection of the subset of rows and the subset of columns defining the dynamic electronic fovea.

3. The device of claim 1, wherein the controller is to drive the subset of pixels of the dynamic electronic fovea at a sampling frequency that is higher than a sampling frequency of other pixels of the imager.

4. The device of claim 1, wherein the controller is to drive the subset of pixels of the dynamic electronic fovea to capture a wavelength spectrum of light that is different from a wavelength spectrum captured by other pixels of the imager.

5. The device of claim 1, wherein the controller is to control the imager to define a plurality of dynamic electronic foveae.

6. The device of claim 5, wherein two dynamic electronic foveae of the plurality of dynamic electronic foveae have different sizes.

7. The device of claim 5, wherein two dynamic electronic foveae of the plurality of dynamic electronic foveae are driven differently from each other.

8. The device of claim 1, wherein the controller is to control the imager to define a dynamic electronic perifovea adjacent the dynamic electronic fovea.
